(19) United States
(12) Patent Application Publication
(10) Pub. No.: US 2023/0110243 A1
(43) Pub. Date: Apr. 13, 2023

(54) Manual Tool Outputting Torque Bidirectionally

(71) Applicants: HANGZHOU GREAT STAR INDUSTRIAL CO., LTD., Hangzhou, Zhejiang (CN); RATCHET SOLUTIONS. INC., Washington (US)

(72) Inventor: Yueming LI, Hangzhou, Zhejiang (CN)

(21) Appl. No.: 17/907,979

(22) PCT Filed: Mar. 3, 2021
(86) PCT No.: PCT/CN2021/078888

§ 371 Date: Aug. 30, 2022

(30) Foreign Application Priority Data
Mar. 3, 2020 (CN) 202010138939.X

(51) Int. Cl. B25B 17/02; B25B 15/04; B25B 13/46

(52) U.S. Cl. CPC B25B 17/02; B25B 15/04; B25B 13/466

(57) ABSTRACT

Disclosed is a manual tool outputting torque bidirectionally. The manual tool includes a handle (100), a main shaft (200), a transmission device (300), a ratchet tooth device (400) and a ratchet wheel switching device (500), wherein when a ratchet wheel switching ring (501) of the ratchet wheel switching device (500) is located at a clockwise position, no matter whether the handle (100) rotates in a clockwise direction or in an anticlockwise direction, the main shaft (200) rotates in the clockwise direction to output torque from the handle (100); when the ratchet wheel switching ring (501) of the ratchet wheel switching device (500) is located at an anticlockwise position, no matter whether the handle (100) rotates in the clockwise direction or in the anticlockwise direction, the main shaft (200) rotates in the anticlockwise direction to output torque from the handle (100); and when the ratchet wheel switching ring (501) of the ratchet wheel switching device (500) is located at a fixed position, the main shaft (200) and the handle (100) rotate in the same direction to output torque from the handle (100), with the output torque being large. The manual tool outputting torque bidirectionally can output the torque by bidirectional rotation of the handle, with the output torque being large, while torque output by an existing screwdriver having bidirectional output is small.

### CROSS-REFERENCE TO RELATED APPLICATION

The disclosure claims the priority to Chinese Patent Application No. CN202010138939.X, filed to the Chinese Patent Office on Mar. 3, 2020 and entitled “Manual Tool Outputting Torque Bidirectionally”, which is incorporated in its entirety herein by reference.

### TECHNICAL FIELD

The present disclosure belongs to a manual tool, and particularly relates to a manual tool outputting torque bidirectionally, which is particularly suitable for screwing tools of a screwdriver, a socket wrench, etc.

### BACKGROUND

During use, an existing screwdriver is held at a handle to rotate only a finite number of cycles, instead of an infinite number of cycles, and it is required to adjust the position of a screw or the hand relative to the handle of the screwdriver to continue a next cycle. During using the screwdriver, the anticlockwise direction of the working rotation direction will be wasted.

The disclosure patent application with the publication No. CN103707233A disclosed a ratchet screwdriver doing work bidirectionally. The ratchet screwdriver includes a screwdriver rod, a sub-handle, a bidirectional transmission device and a switching device; the bidirectional transmission device includes a middle shaft, and two ratchet gears and two driving gears which are mounted on the middle shaft, one ratchet gear, one driving gear and the middle shaft rotating synchronously, the other ratchet gear and the other driving gear being capable of rotating relative to the middle shaft, and the two driving gears being in transmission connection by a primary transmission gear; and the switching device includes a sleeve type knob and a ratchet cage which is mounted in the inner ring of the knob and is capable of rotating relative to the knob, the sub-handle being fixedly connected to the ratchet cage, four ratchet bars being arranged in the ratchet cage, two of the ratchet bars being capable of engaging with or disengaging from one of the ratchet gears under the control of the knob, and the other two of the ratchet bars being capable of engaging with or disengaging from the other ratchet gear under the control of the knob. In the solution, the main shaft can rotate towards one direction no matter whether the handle of the screwdriver rotates clockwise or anticlockwise. However, the screwdriver outputs small bidirectional reversing torque during actual use, and thus cannot satisfy the requirement of the screw for the torque in different work environments.

### SUMMARY

The technical problem to be solved and the technical task provided by the present disclosure are to overcome the defect that torque output by an existing screwdriver having bidirectional output is small, and to provide a manual tool outputting torque bidirectionally, which may output torque by bidirectional rotation of a handle, with the output torque being large.

In order to achieve the above objective, a manual tool outputting torque bidirectionally of the present disclosure includes a handle, a main shaft, a transmission device, a ratchet tooth device and a ratchet wheel switching device, wherein

the main shaft is assembled on the handle by the transmission device and the ratchet tooth device, and a first ratchet wheel is arranged on the main shaft;

the transmission device includes a first gear, a middle gear, a second gear and a holding sleeve, the middle gear engaging with the first gear and the second gear, and enabling the first gear and the second gear to rotate oppositely, the first gear and the main shaft rotating in a same direction, and the second gear being provided with a second ratchet wheel;

the ratchet tooth device is connected with the handle to output torque from the handle, and the ratchet tooth device engages with the first ratchet wheel and the second ratchet wheel by an elastic force; and

the ratchet wheel switching device includes a ratchet wheel switching ring, the ratchet wheel switching ring rotating to change positions among a clockwise position, an anticlockwise position and a fixed position,

the main shaft rotating in a clockwise direction to output torque from the handle when the ratchet wheel switching ring is located at the clockwise position, the main shaft rotating in an anticlockwise direction to output torque from the handle when the ratchet wheel switching ring is located at the anticlockwise position, and the main shaft and the handle rotating in a same direction to output torque from the handle when the ratchet wheel switching ring is located at the fixed position.

In some embodiments, the ratchet tooth device includes: a first ratchet tooth, a second ratchet tooth, a third ratchet tooth and a fourth ratchet tooth, the first ratchet tooth and the second ratchet tooth each engaging with the first ratchet wheel by an elastic force, and the third ratchet tooth and the fourth ratchet tooth each engaging with the second ratchet wheel by an elastic force.

In some embodiments, a first switching part, second switching parts and a slide knob are arranged on the ratchet wheel switching ring, and the slide knob is controlled to enable the ratchet wheel switching ring to rotate to change positions among the clockwise position, the anticlockwise position and the fixed position.

In some embodiments, when the ratchet wheel switching ring is at the clockwise position or the anticlockwise position, the first switching part selectively disengages one of the first ratchet tooth and the second ratchet tooth from the first ratchet wheel, and engages the other one of the first ratchet tooth and the second ratchet tooth with the first ratchet wheel, and the second switching part selectively disengages one of the third ratchet tooth and the fourth ratchet tooth from the second ratchet wheel, and engages the other one of the third ratchet tooth and the fourth ratchet tooth with the second ratchet wheel, such that the main shaft may rotate according to a same expected direction to output the torque from the handle no matter whether the handle rotates clockwise or anticlockwise, the same expected direction being the clockwise direction or the anticlockwise direction.

In some embodiments, when the ratchet wheel switching ring is located at the fixed position, the first ratchet tooth and the second ratchet tooth both engage with the first ratchet wheel, and the third ratchet tooth and the fourth ratchet tooth both engage with the second ratchet wheel, such that the main shaft and the handle rotate in the same direction to output the torque from the handle.

In some embodiments, the first ratchet tooth and the second ratchet tooth are symmetrically arranged, and the third ratchet tooth and the fourth ratchet tooth are symmetrically arranged.

In some embodiments, the fixed position is in a middle of the clockwise position and the anticlockwise position.

In some embodiments, the ratchet tooth device is provided with a ratchet tooth seat fastened to the handle, the first ratchet tooth, the second ratchet tooth, the third ratchet tooth and the fourth ratchet tooth are arranged on the ratchet tooth seat, positioning pits are provided on the ratchet wheel switching ring, a positioning ball is arranged on the ratchet tooth seat, the positioning pits include a clockwise positioning pit corresponding to the clockwise direction, an anticlockwise positioning pit corresponding to the anticlockwise direction and a fixed positioning pit corresponding to the fixed position, and the positioning ball is selectively sunk into one of the clockwise positioning pit, the anticlockwise positioning pit and the fixed positioning pit when the ratchet wheel switching ring rotates to change positions.

In some embodiments, the ratchet tooth seat includes a seat body and a cover body arranged on the seat body, the first ratchet tooth, the second ratchet tooth, the third ratchet tooth and the fourth ratchet tooth being arranged between the seat body and the cover body.

In some embodiments, the first ratchet tooth, the third ratchet tooth, the fourth ratchet tooth and the second ratchet tooth are sequentially arranged in a circumferential direction of the ratchet tooth seat.

In some embodiments, the ratchet tooth seat sleeves the main shaft, such that the main shaft may rotate relative to the ratchet tooth seat, a rear end of the main shaft and the ratchet tooth seat are axially positioned by a check ring, and a front end cover sleeves the main shaft, and is assembled to the main shaft by a radial hinge pin.

In some embodiments, the ratchet wheel switching ring is located in the handle and sleeves the ratchet tooth seat.

In some embodiments, the second gear sleeves the ratchet tooth seat.

In some embodiments, the ratchet wheel switching ring is located in the handle and sleeves the ratchet tooth seat, the second gear sleeves the ratchet tooth seat, and the ratchet wheel switching ring and the second gear are arranged in a spaced manner in an axial direction of the ratchet tooth seat.

In some embodiments, the first ratchet tooth and the second ratchet tooth are symmetrically arranged relative to the first ratchet wheel and are located at positions of two sides of the first ratchet wheel away from a center of the first ratchet wheel respectively, the first switching part is a shift block, the shift block is located between the first ratchet tooth and the second ratchet tooth, and when the ratchet wheel switching ring rotates to change positions, the shift block selectively shifts the first ratchet tooth or the second ratchet tooth to disengage the first ratchet tooth or the second ratchet tooth from the first ratchet wheel or does not shift the first ratchet tooth and the second ratchet tooth to engage the first ratchet tooth and the second ratchet tooth with the first ratchet wheel.

In some embodiments, the ratchet wheel switching ring drives the shift block to rotate synchronously when rotating to change positions, and alternatively, the ratchet wheel switching ring drives the shift block to swing when rotating to change positions.

In some embodiments, the third ratchet tooth and the fourth ratchet tooth are symmetrically arranged relative to the second ratchet wheel, the second switching parts are a first pushing part corresponding to the third ratchet tooth and a second pushing part corresponding to the fourth ratchet tooth which are arranged on an inner wall of the ratchet wheel switching ring, an avoidance groove is provided at a position of the inner wall of the ratchet wheel switching ring located between the first pushing part and the second pushing part, and when rotating to change positions, the ratchet wheel switching ring selectively enables the first pushing part to push the third ratchet tooth away from the second ratchet wheel, or enables the second pushing part to push the fourth ratchet tooth away from the second ratchet wheel, or enables the third ratchet tooth and the fourth ratchet tooth to be located in the avoidance groove without enabling the first pushing part to push the third ratchet tooth away from the second ratchet wheel, nor enabling the second pushing part to push the fourth ratchet tooth away from the second ratchet wheel.

In some embodiments, the transmission device includes a conversion seat fixed to the holding sleeve, the conversion seat sleeving the main shaft, such that the main shaft may rotate relative to the conversion seat, the first gear and the second gear are arranged coaxial with the main shaft, and the at least two middle gears are arranged, and are uniformly distributed on a circumference of the conversion seat.

In some embodiments, the second gear is of an annular structure, and the second ratchet wheel is an inner ratchet wheel arranged on an inner side wall of the second gear.

In some embodiments, the first ratchet tooth, the third ratchet tooth, the fourth ratchet tooth and the second ratchet tooth are sequentially arranged in the circumferential direction of the ratchet tooth seat;

when the ratchet wheel switching ring is located at the anticlockwise position, the first switching part disengages the first ratchet tooth from the first ratchet wheel and engages the second ratchet tooth with the first ratchet wheel, and the first pushing part of the second switching parts disengages the third ratchet tooth from the second ratchet wheel and engages the fourth ratchet tooth with the second ratchet wheel, such that the main shaft rotates in the anticlockwise direction to output the torque from the handle;

when the ratchet wheel switching ring is located at the clockwise position, the first switching part disengages the second ratchet tooth from the first ratchet wheel and engages the first ratchet tooth with the first ratchet wheel, the second pushing part of the second switching parts disengages the fourth ratchet tooth from the second ratchet wheel and engages the third ratchet tooth with the second ratchet wheel, such that the main shaft rotates in the clockwise direction to output the torque from the handle; and

when the ratchet wheel switching ring is located at the fixed position, the first ratchet tooth and the second ratchet tooth both engage with the first ratchet wheel, and the third ratchet tooth and the fourth ratchet tooth both engage with the second ratchet wheel, such that the main shaft and the handle rotate in the same direction to output the torque from the handle. The technical solution of the present disclosure includes the handle, the main shaft, the transmission device, the ratchet tooth device and the ratchet wheel switching device. When the ratchet wheel switching ring of the ratchet wheel switching device is located at the clockwise position, no matter whether the handle rotates in the clockwise direction or in the anticlockwise direction, the main shaft rotates in the clockwise direction to output the torque from the handle; when the ratchet wheel switching ring of the ratchet wheel switching device is located at the anticlockwise position, no matter whether the handle rotates in the clockwise direction or in the anticlockwise direction, the main shaft rotates in the anticlockwise direction to output the torque from the handle; and when the ratchet wheel switching ring of the ratchet wheel switching device is located at the fixed position, the main shaft and the handle rotate in the same direction to output the torque from the handle, with the output torque being large. Thus, the manual tool outputting torque bidirectionally can not only output the torque by means of bidirectional rotation of the handle, but also output larger torque.

### BRIEF DESCRIPTION OF THE DRAWINGS

FIG. 1 is a schematic diagram of a manual tool outputting torque bidirectionally , which is a screwdriver, of the present disclosure;

FIG. 2 is a section view in an A-A direction of FIG. 1;

FIG. 3 is a schematic diagram of structural decomposition of FIG. 1;

FIGS. 4a1 and 4a2 are enlarged schematic diagrams of a B-B section diagram of FIG. 2, and show a case in which a main shaft and a handle rotate in the same direction to output torque from the handle;

FIG. 4b1 shows a case in which the main shaft outputs the torque in an anticlockwise direction in a structure shown in FIG. 4a1, and FIG. 4b2 shows a case in which the main shaft outputs torque in an anticlockwise direction in a structure shown in FIG. 4a2;

FIG. 4c1 shows a case in which the main shaft outputs the torque in a clockwise direction in the structure shown in FIG. 4a1, and FIG. 4c2 shows a case in which the main shaft outputs the torque in a clockwise direction in the structure shown in FIG. 4a2;

FIGS. 5a1 and 5a2 are enlarged schematic diagrams of a C-C section diagram of FIG. 2, and show a case in which a main shaft and a handle rotate in the same direction to output torque from the handle;

FIG. 5b1 shows a case in which the main shaft outputs the torque in an anticlockwise direction in a structure shown in FIG. 5a1, and FIG. 5b2 shows a case in which the main shaft outputs torque in an anticlockwise direction in a structure shown in FIG. 5a2;

FIG. 5c1 shows a case in which the main shaft outputs the torque in a clockwise direction in the structure shown in FIG. 5a1, and FIG. 5c2 shows a case in which the main shaft outputs the torque in a clockwise direction in the structure shown in FIG. 5a2;

FIGS. 6b1 and 6a2 are enlarged schematic diagrams of a D-D section diagram of FIG. 2, and show a case in which a main shaft and a handle rotate in the same direction to output torque from the handle;

FIG. 6b1 shows a case in which the main shaft outputs the torque in an anticlockwise direction in a structure shown in FIG. 6a1, and FIG. 6b2 shows a case in which the main shaft outputs the torque in an anticlockwise direction in a structure shown in FIG. 6a2;

FIG. 6c1 shows a case in which the main shaft outputs the torque in a clockwise direction in the structure shown in FIG. 6b1, and FIG. 6c2 shows a case in which the main shaft outputs the torque in a clockwise direction in the structure shown in FIG. 6a2;

FIG. 7 is a cross-sectional view of a manual tool outputting torque bidirectionally, which is another screwdriver, of the present disclosure; and

FIG. 8 is a section view in an E-E direction of FIG. 7.

### DESCRIPTION OF NUMBERS IN THE FIGURES

100: handle; 101: accommodation cavity; 102: through hole;

200: main shaft; 201: screwdriver head; 202: annular groove; 203: first ratchet wheel; 204: rotation stopping surface; 205: shaft check ring; 206: front end cover; 207: radial hinge pin;

300: transmission device; 301: conversion seat; 302: first gear; 303: middle gear; 304: second gear; 305: holding sleeve; 306: axial through hole; 307: radial shaft; 308: second ratchet wheel; 309: rotation stopping hole; 310: screw;

400: ratchet tooth device; 401: ratchet tooth seat; 402: first ratchet tooth; 403: second ratchet tooth; 404: third ratchet tooth; 405: fourth ratchet tooth; 406: positioning ball;

500: ratchet wheel switching device; 501: ratchet wheel switching ring; 502: first pushing part; 503: second pushing part; 504: shift block; 505: slide knob; 506: clockwise positioning pit; 507: anticlockwise positioning pit; 508: fixed positioning pit; 509: avoidance groove; 510: screw;

T1: tangential force applied by a side surface of the first ratchet tooth 402 to the first ratchet wheel 203 of the main shaft;

N1: thrust generated by a side surface of the fourth ratchet tooth 405 on the second gear 304;

T2: tangential force applied by a side surface of the second ratchet tooth 403 to the first ratchet wheel 203 of the main shaft;

N2: thrust generated by a side surface of the third ratchet tooth 404 on the second gear 304;

T3: tangential force applied by an end surface of the second ratchet tooth 403 to the first ratchet wheel 203 of the main shaft;

N3: reaction force generated by the side surface of the fourth ratchet tooth 405 on the second ratchet wheel 308;

P1: thrust applied by the first ratchet wheel 203 to an end surface of the second ratchet tooth 403;

T4: tangential force applied by the side surface of the second ratchet tooth 403 to the first ratchet wheel 203 of the main shaft;

P2: thrust applied by the second ratchet wheel 308 to an end surface of the fourth ratchet tooth 405;

T5: tangential force applied by the side surface of the first ratchet tooth 402 to the first ratchet wheel 203 of the main shaft;

P3: thrust applied by the second ratchet wheel 308 to an end surface of the third ratchet tooth 404;

T6: tangential force applied by an end surface of the first ratchet tooth 402 to the first ratchet wheel 203 of the main shaft;

N4: reaction force generated by the side surface of the third ratchet tooth 404 on the second ratchet wheel 308; and

P4: thrust applied by the first ratchet wheel 203 to an end surface of the first ratchet tooth 402.

### DETAILED DESCRIPTION OF THE EMBODIMENTS

The present disclosure will be further described below in combination with the drawings.

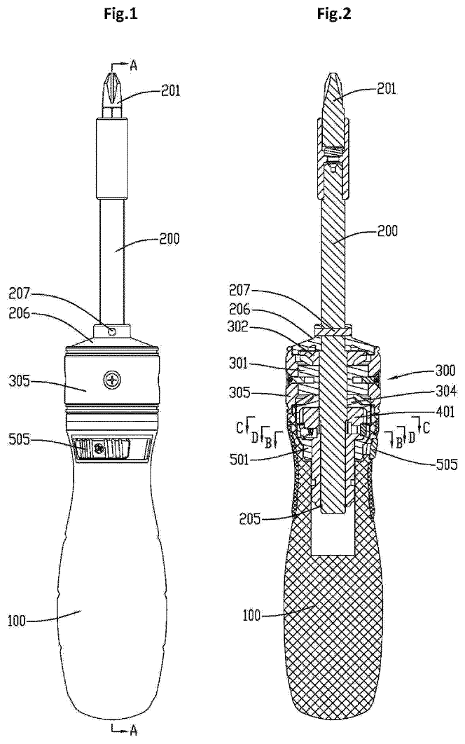

As shown in FIGS. 1-3, a manual tool outputting torque bidirectionally is provided as an example. According to the manual tool in this example, a screwdriver head is arranged at a front end of a main shaft 200, so as to form a screwdriver. During specific implementation, if a sleeve is arranged at the front end of the main shaft 200, a socket wrench is formed. The screwdriver includes a handle 100, a main shaft 200, a transmission device 300, a ratchet tooth device 400 and a ratchet wheel switching device 500.

As shown in FIGS. 1-3, the handle 100 is formed by plastic injection molding, hard plastic may be used inside the handle in order to ensure structural strength, and a surface layer of the handle is coated with flexible materials in order to improve holding feeling. A front of the handle 100 is provided with an accommodation cavity 101, and a through hole 102 is provided on a side wall of the accommodation cavity.

As shown in FIGS. 1-3, the main shaft 200 is of a rod shape, a front end of the main shaft is provided with a screwdriver head 201, a rear end of the main shaft is provided with an annular groove 202, a first ratchet wheel 203 and a rotation stopping surface 204 are arranged in a middle of the main shaft, and the rotation stopping surface 204 is located at a front side of the first ratchet wheel 203. In this embodiment, the first ratchet wheel 203 is an outer ratchet wheel.

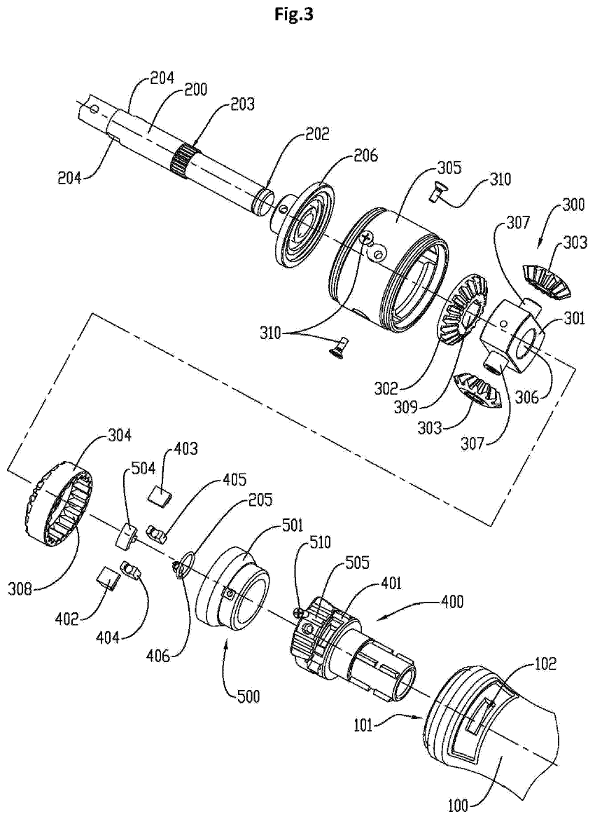

As shown in FIG. 3, the transmission device 300 includes a conversion seat 301, a first gear 302, middle gears 303, a second gear 304 and a holding sleeve 305. A middle of the conversion seat 301 is provided with an axial through hole 306, the first gear 302 and the second gear 304 corresponding to the axial hole 306 are coaxially provided, two radial shafts 307 uniformly distributed on a circumference are arranged on the conversion seat 301, one middle gear 303 is assembled on each of the radial shafts 307, the middle gears 303 are located between the first gear 302 and the second gear 304 and engage with the first gear 302 and the second gear 304 to enable the first gear 302 and the second gear 304 to rotate oppositely, and as shown in the figure, the first gear 302, the middle gears 303 and the second gear 304 are all bevel gears. The second gear 304 is provided with a second ratchet wheel 308, the second gear 304 is of an annular structure, and the second ratchet wheel 308 is an inner ratchet wheel arranged on an inner side wall of the second gear 304. The first gear 302 is provided with a rotation stopping hole 309. The holding sleeve 305 annularly sleeves outer sides of the conversion seat 301 and the middle gears 303 and is fixedly connected to the conversion seat 301 by a screw 310. The transmission device 300 is kept fixed by holding the holding sleeve 305 by a hand, such that when the first gear 302 rotates, the second gear 304 rotates reversely after being transmitted by the middle gears 303.

As shown in FIG. 3, the ratchet tooth device 400 includes a ratchet tooth seat 401, a first ratchet tooth 402, a second ratchet tooth 403, a third ratchet tooth 404 and a fourth ratchet tooth 405, wherein a guide hole (or a guide groove) is provided on the ratchet tooth seat 401, and the first ratchet tooth, the second ratchet tooth, the third ratchet tooth and the fourth ratchet tooth are assembled in the guide hole (or the guide groove). The first ratchet tooth 402, the third ratchet tooth 404, the fourth ratchet tooth 405 and the second ratchet tooth 403 are sequentially arranged in a circumferential direction of the ratchet tooth seat 401. Specifically, the first ratchet tooth 402 and the second ratchet tooth 403 are symmetrically arranged, and the third ratchet tooth 404 and the fourth ratchet tooth 405 are symmetrically arranged. The ratchet tooth device 400 drives the first ratchet tooth 402, the second ratchet tooth 403, the third ratchet tooth 404 and the fourth ratchet tooth 405 to rotate by rotation of the ratchet tooth seat 401, and when rotating along with the ratchet tooth seat 401, the first ratchet tooth 402, the second ratchet tooth 403, the third ratchet tooth 404 and the fourth ratchet tooth 405 may transmit torque, idle or slides according to position states of the first ratchet tooth, the second ratchet tooth, the third ratchet tooth and the fourth ratchet tooth. Moreover, a positioning ball 406 is arranged on the ratchet tooth seat 401, and the positioning ball 406 is supported by a spring, and may retract towards an interior of the ratchet tooth seat 401 when being extruded.

As shown in FIG. 3, the ratchet wheel switching device 500 includes a ratchet wheel switching ring 501, wherein a first switching part, second switching parts and a slide knob 505 are arranged on the ratchet wheel switching ring 501, and the slide knob 505 is controlled to enable the ratchet wheel switching ring 501 to rotate to change positions among a clockwise position, an anticlockwise position and a fixed position. Specifically, positioning pits are provided on the ratchet wheel switching ring 501, and include a clockwise positioning pit 506, an anticlockwise positioning pit 507 and a fixed positioning pit 508 which correspond to the clockwise position, the anticlockwise position and the fixed position respectively, and the fixed positioning pit is located between the clockwise positioning pit and the anticlockwise positioning pit, such that the fixed position is located in a middle of the clockwise position and the anticlockwise position. The first switching part is a shift block 504, in order to facilitate assembly, the shift block 504 shown in the figure is an independent part, a mounting groove is provided on an inner wall of the ratchet wheel switching ring 501, and the shift block 504 is assembled in the mounting groove. The second switching parts are a first pushing part 502 and a second pushing part 503 which are arranged on an inner wall of the ratchet wheel switching ring 501 and correspond to the third ratchet tooth 404 and the fourth ratchet tooth 405 respectively. An avoidance groove 509 is provided at a position of the inner wall of the ratchet wheel switching ring 501 located between the first pushing part 502 and the second pushing part 503. Also, in order to facilitate assembly, the slide knob 505 is assembled to the ratchet wheel switching ring 501 by a screw 510.

In this embodiment, the clockwise direction refers to a clockwise direction of rotation viewed in an axial direction from the screwdriver head to the handle, and the anticlockwise direction refers to an anticlockwise direction of rotation viewed in the axial direction from the screwdriver head to the handle.

The handle 100, the main shaft 200, the transmission device 300, the ratchet tooth device 400, and the ratchet wheel switching device 500 are assembled together according to the relation as shown in FIGS. 1-6c2 and described below.

The ratchet tooth seat 401 is fastened to the handle 100, and the first ratchet tooth 402, the second ratchet tooth 403, the third ratchet tooth 404, and the fourth ratchet tooth 405 are assembled in the guide hole (or the guide groove) of the ratchet tooth seat 401. The ratchet tooth seat 401 and the handle 100 are fastened, and the ratchet tooth seat 401 may be assembled in the accommodation cavity in the front end of the handle 100 in an interference fit and a bonding manner. In view of that a rear of the handle 100 shown in the figures is closed, before the ratchet tooth seat 401 is assembled, a rear end of the main shaft 200 needs to penetrate the ratchet tooth seat 401 and a shaft check ring 205 assembled in the annular groove 202 in the rear end of the main shaft 200 is used to axially position the main shaft 200 and the ratchet tooth seat 401. When the rear end of the handle 100 is provided with an assembling through hole in communication with the accommodation cavity, the main shaft 200 may be assembled after the ratchet tooth seat 401 is assembled. The ratchet tooth seat 401 sleeves the main shaft 200 or the main shaft 200 penetrates the ratchet tooth seat 401, such that the main shaft 200 may rotate relative to the ratchet tooth seat 401, and the first ratchet tooth 402 and the second ratchet tooth 403 each engage with the first ratchet wheel on the main shaft 200 by an elastic force of the spring.

The ratchet wheel switching ring 501 is located in the accommodation cavity 101 of the handle 100 and sleeves the ratchet tooth seat 401, the shift block 504 serving as the first switching part is located between the first ratchet tooth 402 and the second ratchet tooth 403, and the first pushing part 502, the second pushing part 503 and the avoidance groove 509 correspond to the third ratchet tooth 404 and the fourth ratchet tooth 405 in an axial position, so as to enable the first pushing part 502 to push away the third ratchet tooth 404, enable the second pushing part 503 to push away the fourth ratchet tooth 405, and enable the third ratchet tooth 404 and the fourth ratchet tooth 405 to be located in the avoidance groove at the same time when the ratchet wheel switching ring 501 rotates. The positioning ball 406 corresponds to the positioning pits in the axial direction, so as to enable the positioning ball to be selectively located in the clockwise positioning pit 506, the anticlockwise positioning pit 507 and the fixed positioning pit 508 when the ratchet wheel switching ring 501 rotates. The slide knob 505 is arranged at the through hole 102 on a side wall of the accommodation cavity of the handle 100 from an outer side of the handle 100 and is connected to the ratchet wheel switching ring 501 by the screw 510, such that the ratchet wheel switching ring 501 may be restrained, that is, the ratchet wheel switching ring 501 is prohibited from axially moving to ensure position relations between the shift block 504 and the first ratchet tooth 402 and the second ratchet tooth 403, position relations between the first pushing part 502, the second pushing part 503, the avoidance groove and the third ratchet tooth 404 and the fourth ratchet tooth 405 and position relations between the positioning ball and the positioning pit. Moreover, the slide knob 505 is restrained by the through hole to slide within a certain angle range, so as to drive the ratchet wheel switching ring 501 to rotate to change positions, and the positioning ball is selectively located in the clockwise positioning pit, the anticlockwise positioning pit and the fixed positioning pit, such that the ratchet wheel switching ring 501 is positioned at the required clockwise position, the required anticlockwise position or the required fixed position. To guide and prompt a user, several positions on the handle 100 corresponding to the slide knob 505 may be marked to indicate a torque output direction of the main shaft 200.

In an assembly state, the first ratchet tooth 402 and the second ratchet tooth 403 are symmetrically arranged relative to the first ratchet wheel 203 and are located at positions of two sides of the first ratchet wheel away from a center of the first ratchet wheel respectively. When the ratchet wheel switching ring 501 rotates to change positions, the shift block 504 selectively shifts the first ratchet tooth 402 or the second ratchet tooth 403 to disengage the first ratchet tooth or the second ratchet tooth from the first ratchet wheel or does not shift the first ratchet tooth 402 and the second ratchet tooth 403 to engage the first ratchet tooth 402 and the second ratchet tooth 403 with the first ratchet wheel.

The second gear 304 sleeves a front end of the ratchet tooth seat 401 and may rotate relative to the ratchet tooth seat 401, and the second gear 304 and the ratchet wheel switching ring 501 are arranged in a spaced manner in an axial direction of the ratchet tooth seat 401. The third ratchet tooth 404 and the fourth ratchet tooth 405 each engage with the second ratchet wheel 308 of the second gear 304 by an elastic force. The conversion seat 301 sleeves the main shaft 200 and enables the main shaft 200 to rotate relative to the conversion seat 301, and the holding sleeve 305 is in butt joint with the front end of the handle 100, such that the second gear 304 is shielded. The first gear 302 sleeves the main shaft 200, and a rotation stopping hole 309 of the first gear 302 matches the rotation stopping surface 204 on the main shaft 200, such that the the first gear 302 and the main shaft 200 may rotate together in the same direction; and the first gear 302 is also shielded. Moreover, the first gear 302, the second gear 304 and the main shaft 200 are arranged coaxially, and the two middle gears 303 are arranged and are uniformly distributed on a circumference of the conversion seat 301.

In an assembly state, the third ratchet tooth 404 and the fourth ratchet tooth 405 are parallel to each other and are symmetrically arranged relative to the second ratchet wheel 308, and when the ratchet wheel switching ring 501 rotates to change positions, the ratchet wheel switching ring 501 selectively enables the first pushing part 502 to push the third ratchet tooth 404 away from the second ratchet wheel 308, or enables the second pushing part 503 to push the fourth ratchet tooth 405 away from the second ratchet wheel 308, or enables the third ratchet tooth 404 and the fourth ratchet tooth 405 to be located in the avoidance groove 509, without enabling the first pushing part 502 to push the third ratchet tooth 404 away from the second ratchet wheel 308, nor enabling the second pushing part 503 to push the fourth ratchet tooth 405 away from the second ratchet wheel 308.

As shown in FIG. 2, the front end cover 206 sleeves the main shaft 200 and is assembled to the main shaft 200 by a radial hinge pin 207, such that the front end cover and the main shaft 200 rotates together and restricts axial movement of the front end cover relative to the main shaft 200. Accordingly, the main shaft 200 is axially positioned by the shaft check ring 205 and the front end cover 206 at a rear end of the main shaft and may not move axially. The transmission device 300 and the ratchet wheel switching device 500 are also positioned between the front end cover and the handle 100 to keep working positions of the transmission device and the ratchet wheel switching device.

As previously described, the main shaft 200 is assembled on the handle 100 by the transmission device 300 and the ratchet tooth device 400.

On the basis of the structure, when the ratchet wheel switching ring 501 is located at the clockwise position, no matter whether the handle 100 rotates in the clockwise direction or the handle 100 rotates in the anticlockwise direction, the main shaft 200 may rotate in the clockwise direction to output torque from the handle 100; when the ratchet wheel switching ring 501 is located at the anticlockwise position, no matter whether the handle 100 rotates in the clockwise direction or the handle 100 rotates in the anticlockwise direction, the main shaft 200 may rotate in the anticlockwise direction to output torque from the handle 100; and when the ratchet wheel switching ring 501 is located at the fixed position, the main shaft 200 and the handle 100 may rotate in the same direction to output torque from the handle 100.

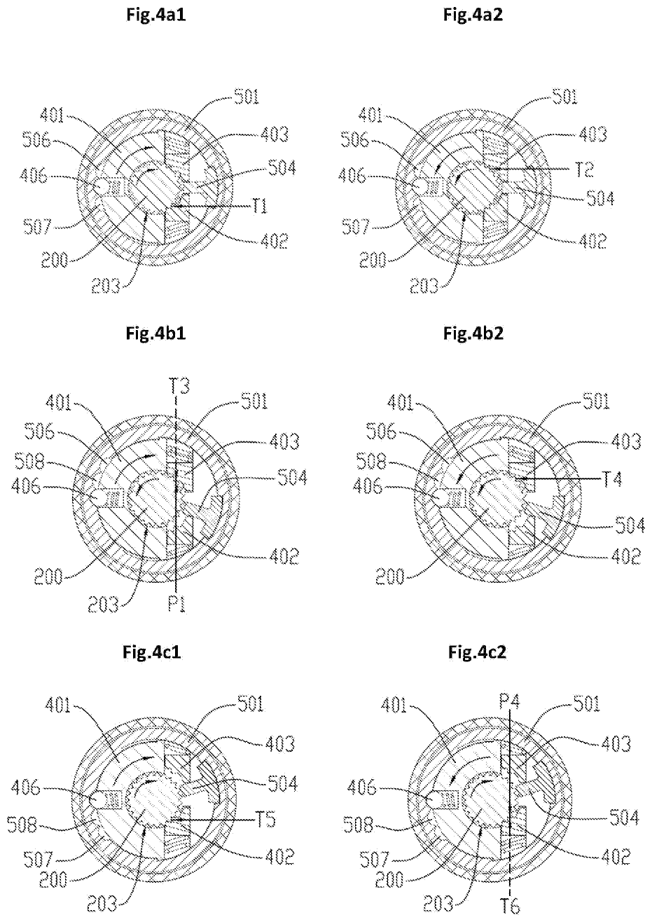

As shown in FIGS. 4a1, 4a2, 5a1, 5a2, 6b1 and 6a2, the ratchet wheel switching ring 501 is located at the fixed position. The shift block 504 neither shifts the first ratchet tooth 402, nor shifts the second ratchet tooth 403, and the first ratchet tooth 402 and the second ratchet tooth 403 both engage with the first ratchet wheel 203. The third ratchet tooth 404 and the fourth ratchet tooth 405 are both located in the avoidance groove 509, the first pushing part 502 does not push the third ratchet tooth 404 away from the second ratchet wheel 308, the second pushing part 503 does not push the fourth ratchet tooth 405 away from the second ratchet wheel 308, and the third ratchet tooth 404 and the fourth ratchet tooth 405 both engage with the second ratchet wheel 308. In use, the main shaft 200 and the handle 100 rotate in the same direction to output the torque from the handle 100 only by rotating the handle 100.

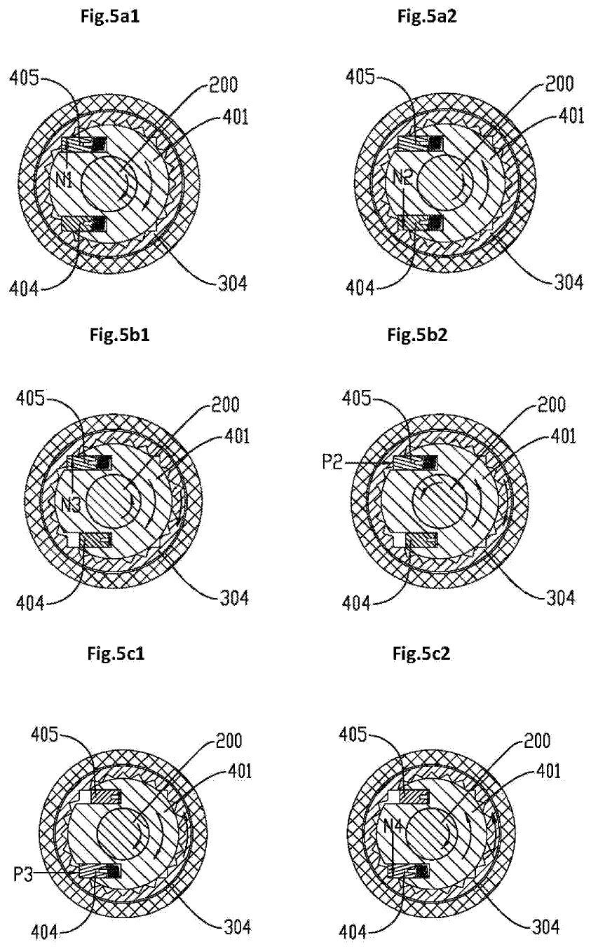

As shown in FIGS. 4a1, 5a1 and 6a1, when the handle 100 is rotated in the clockwise direction, the ratchet tooth seat 401 rotates in the clockwise direction along with the handle, a side surface of the first ratchet tooth 402 applies a tangential force T1 shown in FIG. 4a1 to the first ratchet wheel 203 of the main shaft 200, a reaction force of the tangential force acts on the side surface of the first ratchet tooth 402, a position state of the first ratchet tooth 402 is not changed, and the first ratchet tooth 402 enable the first gear 302 and main shaft 200 to follow the handle 100 to rotate clockwise. Aside surface of the fourth ratchet tooth 405 generates a thrust N1 shown in FIG. 5a1 on the second gear 304, a reaction force of the thrust acts on the side surface of the fourth ratchet tooth 405, and a position state of the fourth ratchet tooth 405 is not changed. Therefore, the fourth ratchet tooth 405 enable the second gear 304 to follow the handle 100 to rotate clockwise. Therefore, the first gear 302, the second gear 304 and the ratchet tooth seat 401 rotate synchronously in the clockwise direction, and the holding sleeve 305 and the handle 100 are static relative to each other. In this case, the first gear 302 and the second gear 304 are in a deadlocked state and do not rotate relative to each other, and the torque of the handle 100 is directly transmitted to the main shaft 200 to enable the main shaft 200 to rotate in the clockwise direction along with the handle 100, to output torque, thereby increasing torque transmission between the handle 100 and the main shaft 200. Arc arrows marked on the main shaft 200 and the ratchet tooth seat 401 in the figures show rotation directions of the main shaft 200 and the handle 100.

As shown in FIGS. 4a2, 5a2 and 6a2, when the handle 100 is rotated in the anticlockwise direction, the ratchet tooth seat 401 rotates in the anticlockwise direction along with the handle, a side surface of the second ratchet tooth 403 applies a tangential force T2 as shown in FIG. 4a2 to the first ratchet wheel 203 of the main shaft 200, a reaction force of the tangential force acts on the side surface of the second ratchet tooth 403, a position state of the second ratchet tooth 403 is not changed, and the second ratchet tooth 403 enable the first gear 302 and the main shaft 200 to follow the handle 100 to rotate anticlockwise. A side surface of the third ratchet tooth 404 generates a thrust N2 shown in FIG. 5a2 on the second gear 304, a reaction force of the thrust acts on the side surface of the third ratchet tooth 404, and a position state of the third ratchet tooth 404 is not changed. Therefore, the third ratchet tooth 404 enable the second gear 304 to follow the handle 100 to rotate anticlockwise. Therefore, the first gear 302, the second gear 304 and the conversion seat 301 rotate synchronously in the anticlockwise direction, and the holding sleeve 305 and the handle 100 are static relative to each other. In this case, the first gear 302 and the second gear 304 are in a deadlocked state and do not rotate relative to each other, and the torque of the handle 100 is directly transmitted to the main shaft 200 to enable the main shaft 200 to rotate in the anticlockwise direction along with the handle 100, to output the torque, thereby increasing torque transmission between the handle 100 and the main shaft 200. Arc arrows marked on the main shaft 200 and the ratchet tooth seat 401 in the figures show rotation directions of the main shaft 200 and the handle 100.

Thus, when the ratchet wheel switching ring 501 is located at the fixed position, the main shaft 200 and the handle 100 rotate in the same direction to output the torque from the handle 100, with the output torque being large.

As shown in FIGS. 4b1, 4b2, 5b1, 5b2, 6b1 and 6b2, the ratchet wheel switching ring 501 is in the anticlockwise position. The shift block 504 pushes the first ratchet tooth 402 away from the first ratchet wheel 203, the first ratchet tooth 402 are disengaged from the first ratchet wheel 203, and the second ratchet tooth 403 engage with the first ratchet wheel 203. The third ratchet tooth 404 are pushed away from the second ratchet wheel 308 by the first pushing part 502, the third ratchet tooth 404 are disengaged from the second ratchet wheel 308, the fourth ratchet tooth 405 are located in the avoidance groove 509, and the fourth ratchet tooth 405 engage with the second ratchet wheel 308. During use, the holding sleeve 305 is held with the hand to keep the holding sleeve 305 and the conversion seat 301 static, and the handle 100 is held with the hand to apply the torque to the handle 100 to enable the handle 100 to rotate relative to the holding sleeve 305 and the conversion seat 301.

As shown in FIGS. 4b1, 5b1 and 6b1, when the handle 100 is rotated in the clockwise direction relative to the holding sleeve 305, the ratchet tooth seat 401 rotates in the clockwise direction along with the handle, and the first ratchet tooth 402 and the third ratchet tooth 404 idle along with the ratchet tooth seat 401. The side surface of the fourth ratchet tooth 405 applies a thrust N3 as shown in FIG. 5b1 to the second ratchet wheel 308 of the second gear 304, a reaction force of the thrust acts on the side surface of the fourth ratchet tooth 405, and a position state of the fourth ratchet tooth 405 is not changed, such that the fourth ratchet tooth 405 transmits the torque from the handle 100 to the second gear 304 to enable the second gear 304 to follow the handle to rotate clockwise. Clockwise rotation of the second gear 304 is transmitted to the first gear 302 through the middle gears 303 to enable the first gear 302 rotates anticlockwise. Therefore, the first gear 302 drives the main shaft 200 to rotate in the anticlockwise direction to output the torque. An end surface of the second ratchet tooth 403 applies a tangential force T3 as shown in FIG. 4b1 to the first ratchet wheel 203 of the main shaft 200, and a reaction force of the tangential force acts on the side surface of the second ratchet tooth 403. That is, the first ratchet wheel 203 applies a thrust P1 as shown in FIG. 4b1 to the end surface of the second ratchet tooth 403 to enable the second ratchet tooth 403 to retracts towards the ratchet tooth seat 401 to slide on the first ratchet wheel 203. Therefore, under relative rotation of the handle 100 and the holding sleeve 305, the main shaft 200 rotates in the anticlockwise direction to output the torque. Arc arrows marked on the main shaft 200, the ratchet tooth seat 401, and the second gear 304 in the figures show rotation directions of the main shaft 200, the handle 100, and the second gear 304.

As shown in FIGS. 4b2, 5b2 and 6b2, when the handle 100 is rotated in the anticlockwise direction relative to the holding sleeve 305, the ratchet tooth seat 401 rotates in the anticlockwise direction along with the handle, the first ratchet tooth 402 and the third ratchet tooth 404 idle along with the ratchet tooth seat 401, the side surface of the second ratchet tooth 403 applies a tangential force T4 shown in FIG. 4b2 to the first ratchet wheel 203 of the main shaft 200, a reaction force of the tangential force acts on the side surface of the second ratchet tooth 403, and a position state of the second ratchet tooth 403 is not changed, such that the torque from the handle 100 is directly transmitted to the main shaft 200 by the second ratchet tooth 403 to enable the main shaft 200 to rotate in the anticlockwise direction along with the handle 100, to output the torque. Arc arrows marked on the main shaft 200, the ratchet tooth seat 401, and the second gear 304 in the figures show rotation directions of the main shaft 200, the handle 100, and the second gear 304. When the main shaft 200 rotates in the anticlockwise direction along with the handle 100, to output the torque, the first gear 302 rotates in the anticlockwise direction along with the main shaft and enables the second gear 304 to rotate in the clockwise direction by a transmission of the middle gears 303. When the second gear 304 rotates in the clockwise direction, the second ratchet wheel 308 applies a thrust P2 shown in FIG. 5b2 to an end surface of the fourth ratchet tooth 405 to enable the fourth ratchet tooth 405 to retract towards the ratchet tooth seat 401 to slide on the second ratchet wheel 308.

Thus, when the ratchet wheel switching ring 501 is located at the anticlockwise position, no matter whether the handle 100 rotates in the clockwise direction or in the anticlockwise direction, the main shaft 200 rotates in the anticlockwise direction to output the torque from the handle 100.

As shown in FIGS. 4c1, 4c2, 5c1, 5c2, 6c1 and 6c2, the ratchet wheel switching ring 501 is located in the clockwise position. The shift block 504 pushes the second ratchet tooth 403 away from the first ratchet wheel 203, the second ratchet tooth 403 are disengaged from the first ratchet wheel 203, and the first ratchet tooth 402 engage with the first ratchet wheel 203. The fourth ratchet tooth 405 are pushed away from the second ratchet wheel 308 by the second pushing part 503, the fourth ratchet tooth 405 are disengaged from the second ratchet wheel 308, the third ratchet tooth 404 are located in the avoidance groove 509, and the third ratchet tooth 404 engage with the second ratchet wheel 308. During use, the holding sleeve 305 is held with the hand to keep the holding sleeve 305 and the conversion seat 301 static, and the handle 100 is held with the hand to apply the torque to the handle 100 to enable the handle 100 to rotate relative to the holding sleeve 305 and the conversion seat 301.

As shown in FIGS. 4c1, 5c1 and 6c1, when the handle 100 is rotated in the clockwise direction relative to the holding sleeve 305, the ratchet tooth seat 401 rotates in the clockwise direction along with the handle, the second ratchet tooth 403 and the fourth ratchet tooth 405 idle along with the ratchet tooth seat 401, the side surface of the first ratchet tooth 402 applies a tangential force T5 shown in FIG. 4c1 to the first ratchet wheel 203 of the main shaft 200, a reaction force of the tangential force acts on the side surface of the first ratchet tooth 402, and a position state of the first ratchet tooth 402 may not be changed, such that the torque from the handle 100 is directly transmitted to the main shaft 200 by the first ratchet tooth 402 to enable the main shaft 200 to rotate in the clockwise direction along with the handle 100, to output torque. Arc arrows marked on the main shaft 200, the ratchet tooth seat 401 and the second gear 304 in the figures show rotation directions of the main shaft 200, the handle 100, and the second gear 304. When the main shaft 200 rotates in the clockwise direction along with the handle 100, to output the torque, the first gear 302 rotates in the clockwise direction along with the handle and enables the second gear 304 to rotate in the anticlockwise direction by a transmission of the middle gears 303, and when the second gear 304 rotates in the anticlockwise direction, the second ratchet wheel 308 applies a thrust P3 shown in FIG. 5c1 to the end surface of the third ratchet wheel 404 to enable the third ratchet tooth 404 to retract towards the ratchet tooth seat 401 to slide on the second ratchet wheel 308.

As shown in FIGS. 4c2, 5c2 and 6c2, when the handle 100 is rotated in the anticlockwise direction relative to the holding sleeve 305, the ratchet tooth seat 401 rotates in the anticlockwise direction along with the handle, and the second ratchet tooth 403 and the fourth ratchet tooth 405 idle along with the ratchet tooth seat 401. The side surface of the third ratchet tooth 404 applies a thrust N4 as shown in FIG. 5c2 to the second ratchet wheel 308 of the second gear 304, a reaction force of the thrust acts on the side surface of the third ratchet tooth 404, and a position state of the third ratchet tooth 404 is not changed, such that the third ratchet tooth 404 transmits torque from the handle 100 to the second gear 304 to enable the second gear 304 to follow the handle to rotate anticlockwise. The anticlockwise rotation of the second gear 304 is transmitted to the first gear 302 by the middle gears 303 to enable the first gear 302 to rotate clockwise, such that the first gear 302 drives the main shaft 200 to rotate in the clockwise direction to output the torque. An end face of the first ratchet tooth 402 applies a tangential force T6 as shown in FIG. 4c2 to the first ratchet wheel 203 of the main shaft 200, and a reaction force of the tangential force acts on the side surface of the first ratchet tooth 402. That is, the first ratchet wheel 203 applies a thrust P4 as shown in FIG. 4c2 to the end surface of the first ratchet tooth 402 to enable the first ratchet tooth 402 to retract towards the ratchet tooth seat 401 to slide on the first ratchet wheel 203. Therefore, under relative rotation of the handle 100 and the holding sleeve 305, the main shaft 200 rotates in the clockwise direction to output the torque. Arc arrows marked on the main shaft 200, the ratchet tooth seat 401, and the second gear 304 in the figures show rotation directions of the main shaft 200, the handle 100, and the second gear 304.

Thus, when the ratchet wheel switching ring 501 is located at the clockwise position, no matter whether the handle 100 rotates in the clockwise direction or in the anticlockwise direction, the main shaft 200 rotates in the clockwise direction to output the torque from the handle 100.

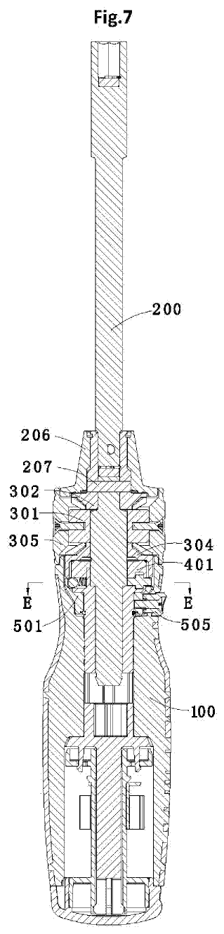

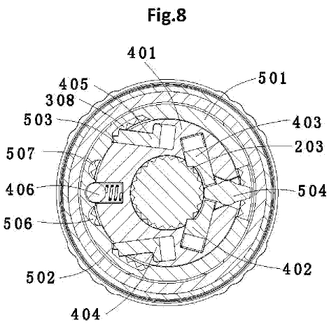

FIGS. 7 and 8 show a screwdriver according to another form of the present disclosure. The screwdriver shown in FIGS. 7 and 8 has basically the same working principle as the screwdriver described above. A ratchet wheel switching ring of a ratchet wheel switching device also has a clockwise position, an anticlockwise position and a fixed position. When the ratchet wheel switching ring is located at the clockwise position, no matter whether the handle rotates in the clockwise direction or in an anticlockwise direction, a main shaft rotates in a clockwise direction to output torque from a handle; when the ratchet wheel switching ring of the ratchet wheel switching device is located at the anticlockwise position, no matter whether the handle rotates in the clockwise direction or in the anticlockwise direction, the main shaft rotates in the anticlockwise direction to output torque from the handle; and when the ratchet wheel switching ring of the ratchet wheel switching device is located at the fixed position, the main shaft and the handle rotate in the same direction to output torque from the handle, with the output torque being large.

The screwdriver shown in FIGS. 7 and 8 mainly differs from the screwdriver described above in a structure of a ratchet tooth seat, a structure of a shift block, a structure of the ratchet wheel switching ring and specific shapes of a first ratchet tooth, a second ratchet tooth, a third ratchet tooth and a fourth ratchet tooth, which will be introduced one by one below.

In a structure of the screwdriver shown in FIGS. 7 and 8, the ratchet tooth seat 401 includes a seat body and a cover body, wherein accommodating grooves for accommodating the first ratchet tooth, the second ratchet tooth, the third ratchet tooth and the fourth ratchet tooth are provided on the seat body, and the cover body covers the seat body, so as to assemble the first ratchet tooth, the second ratchet tooth, the third ratchet tooth and the fourth ratchet tooth between the seat body and the cover body. The above structure is easy to machine, and machining precision is easy to ensure.

The shift block 504 is arranged between the seat body and the cover body in a swinging manner, a first end of the shift block 504 is driven by the ratchet wheel switching ring 501, and a second end of the shift block 504 may shift the first ratchet tooth 402 or the second ratchet tooth 403, such that the first ratchet tooth 402 or the second ratchet tooth 403 can disengage from a first ratchet wheel 203.

The ratchet wheel switching ring 501 is provided with a groove for driving the shift block 504, and two groove walls of the groove may drive the shift block 504 to swing. An inner wall of the ratchet wheel switching ring 501 is provided with a first pushing part 502, a second pushing part 503, a first avoidance groove adjacent to the first pushing part 502 and a second avoidance groove adjacent to the second pushing 503. A clockwise positioning pit 506, an anticlockwise positioning pit 507 and a fixed positioning pit 508 are also arranged on the ratchet wheel switching ring 501.

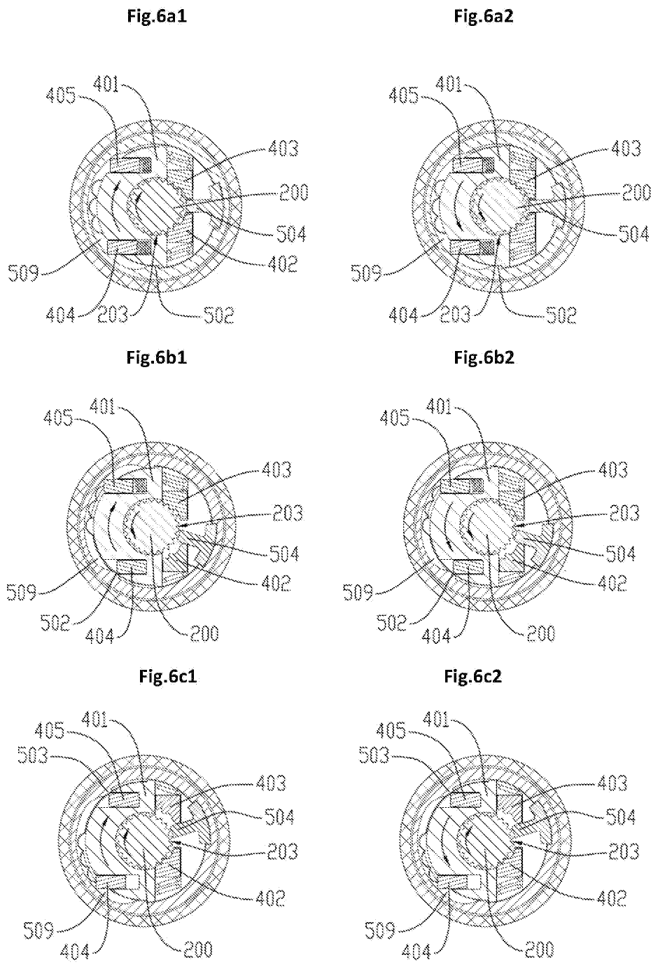

As the shift block 504 are arranged swingable, a driving direction of the ratchet wheel switching ring 501 is different from that of the screwdriver described above. In the structure of the screwdriver shown in FIGS. 1-3, as shown in FIGS. 6b1 and 6b2, the ratchet wheel switching ring rotates clockwise to the anticlockwise position, and as shown in FIGS. 6c1 and 6c2, the ratchet wheel switching ring rotates anticlockwise to the clockwise position. In the structure of the screwdriver shown in FIGS. 7 and 8, the ratchet wheel switching ring rotates clockwise to the clockwise position, and the ratchet wheel switching ring rotates anticlockwise to reach the anticlockwise position.

In the structure of the screwdriver shown in FIGS. 7 and 8, the first ratchet tooth 402 and the second ratchet tooth 403 each match the first ratchet wheel 203 by one tooth, and the third ratchet tooth 404 and the fourth ratchet tooth 405 each match a second ratchet wheel 308 by two teeth. The above structure may effectively ensure reliability of torque transmission, and moreover, ensure smoothness in an adjusting process.

What is claimed is:

1. A manual tool outputting torque bidirectionally, comprising a handle, a main shaft, a transmission device, a ratchet tooth device and a ratchet wheel switching device, wherein
the main shaft is assembled on the handle by the transmission device and the ratchet tooth device, and a first ratchet wheel is arranged on the main shaft;
the transmission device comprises a first gear, a middle gear, a second gear and a holding sleeve, the middle gear engaging with the first gear and the second gear, and enabling the first gear and the second gear to rotate oppositely, the first gear and the main shaft rotating in a same direction, and the second gear being provided with a second ratchet wheel;
the ratchet tooth device is connected with the handle, to output torque from the handle, and the ratchet tooth device engages with the first ratchet wheel and the second ratchet wheel by an elastic force; and
the ratchet wheel switching device comprises a ratchet wheel switching ring, the ratchet wheel switching ring rotating to change positions among a clockwise position, an anticlockwise position and a fixed position,
the main shaft rotating in a clockwise direction to output torque from the handle when the ratchet wheel switching ring is located at the clockwise position, the main shaft rotating in an anticlockwise direction to output torque from the handle when the ratchet wheel switching ring is located at the anticlockwise position, and the main shaft and the handle rotating in a same direction to output torque from the handle when the ratchet wheel switching ring is located at the fixed position.

2. The manual tool outputting torque bidirectionally as claimed in claim 1, wherein the ratchet tooth device comprises:
a first ratchet tooth, a second ratchet tooth, a third ratchet tooth and a fourth ratchet tooth, the first ratchet tooth and the second ratchet tooth each engaging with the first ratchet wheel by an elastic force, and the third ratchet tooth and the fourth ratchet tooth each engaging with the second ratchet wheel by an elastic force.

3. The manual tool outputting torque bidirectionally as claimed in claim 2, wherein
a first switching part, second switching parts and a slide knob are arranged on the ratchet wheel switching ring, and the slide knob is controlled to enable the ratchet wheel switching ring to rotate to change positions among the clockwise position, the anticlockwise position and the fixed position.

4. The manual tool outputting torque bidirectionally as claimed in claim 3, wherein
when the ratchet wheel switching ring is at the clockwise position or the anticlockwise position, the first switching part selectively disengages one of the first ratchet tooth and the second ratchet tooth from the first ratchet wheel, and engages the other one of the first ratchet tooth and the second ratchet tooth with the first ratchet wheel, and the second switching part selectively disengages one of the third ratchet tooth and the fourth ratchet tooth from the second ratchet wheel, and engages the other one of the third ratchet tooth and the fourth ratchet tooth with the second ratchet tooth wheel such that the main shaft can rotate according to a same expected direction to output the torque from the handle no matter whether the handle rotates clockwise or anticlockwise, the same expected direction being the clockwise direction or the anticlockwise direction.

5. The manual tool outputting torque bidirectionally as claimed in claim 3, wherein
when the ratchet wheel switching ring is located at the fixed position, the first ratchet tooth and the second ratchet tooth both engage with the first ratchet wheel, and the third ratchet tooth and the fourth ratchet tooth both engage with the second ratchet wheel, such that the main shaft and the handle rotate in the same direction to output the torque from the handle.

6. The manual tool outputting torque bidirectionally as claimed in claim 3, wherein the first ratchet tooth and the second ratchet tooth are symmetrically arranged, and the third ratchet tooth and the fourth ratchet tooth are symmetrically arranged.

7. The manual tool outputting torque bidirectionally as claimed in claim 3, wherein the fixed position is in a middle of the clockwise position and the anticlockwise position.

8. The manual tool outputting torque bidirectionally as claimed in claim 3, wherein the ratchet tooth device is provided with a ratchet tooth seat fastened to the handle, the first ratchet tooth, the second ratchet tooth, the third ratchet tooth and the fourth ratchet tooth are arranged on the ratchet tooth seat, positioning pits are provided on the ratchet wheel switching ring, a positioning ball is arranged on the ratchet tooth seat, the positioning pits comprise a clockwise positioning pit corresponding to the clockwise direction, an anticlockwise positioning pit corresponding to the anticlockwise direction and a fixed positioning pit corresponding to the fixed position, and the positioning ball is selectively sunk into one of the clockwise positioning pit, the anticlockwise positioning pit and the fixed positioning pit when the ratchet wheel switching ring rotates to change positions.

9. The manual tool outputting torque bidirectionally as claimed in claim 8, wherein the ratchet tooth seat comprises a seat body and a cover body arranged on the seat body, the first ratchet tooth, the second ratchet tooth, the third ratchet tooth and the fourth ratchet tooth being arranged between the seat body and the cover body.

10. The manual tool outputting torque bidirectionally as claimed in claim 8, wherein
the first ratchet tooth, the third ratchet tooth, the fourth ratchet tooth and the second ratchet tooth are sequentially arranged in a circumferential direction of the ratchet tooth seat.

11. The manual tool outputting torque bidirectionally as claimed in claim 8, wherein the ratchet tooth seat sleeves the main shaft such that the main shaft can rotate relative to the ratchet tooth seat, a rear end of the main shaft and the ratchet tooth seat are axially positioned by a check ring, and a front end cover sleeves the main shaft, and is assembled to the main shaft by a radial hinge pin.

12. The manual tool outputting torque bidirectionally as claimed in claim 8, wherein the ratchet wheel switching ring is located in the handle and sleeves the ratchet tooth seat.

13. The manual tool outputting torque bidirectionally as claimed in claim 8, wherein the second gear sleeves the ratchet tooth seat.

14. The manual tool outputting torque bidirectionally as claimed in claim 8, wherein the ratchet wheel switching ring is located in the handle and sleeves the ratchet tooth seat, the second gear sleeves the ratchet tooth seat, and the ratchet wheel switching ring and the second gear are arranged in a spaced manner in an axial direction of the ratchet tooth seat.

15. The manual tool outputting torque bidirectionally as claimed in claim 3, wherein the first ratchet tooth and the second ratchet tooth are symmetrically arranged relative to the first ratchet wheel and are located at positions of two sides of the first ratchet wheel away from a center of the first ratchet wheel respectively, the first switching part is a shift block, the shift block is located between the first ratchet tooth and the second ratchet tooth, and when the ratchet wheel switching ring rotates to change positions, the shift block selectively shifts the first ratchet tooth or the second ratchet tooth to disengage the first ratchet tooth or the second ratchet tooth from the first ratchet wheel or does not shift the first ratchet tooth and the second ratchet tooth to engage the first ratchet tooth and the second ratchet tooth with the first ratchet wheel.

16. The manual tool outputting torque bidirectionally as claimed in claim 15, wherein the ratchet wheel switching ring drives the shift block to rotate synchronously when rotating to change positions, and alternatively, the ratchet wheel switching ring drives the shift block to swing when rotating to change positions.

17. The manual tool outputting torque bidirectionally as claimed in claim 3, wherein the third ratchet tooth and the fourth ratchet tooth are symmetrically arranged relative to the second ratchet wheel, the second switching parts are a first pushing part corresponding to the third ratchet tooth and a second pushing part corresponding to the fourth ratchet tooth which are arranged on an inner wall of the ratchet wheel switching ring , an avoidance groove is provided at a position of the inner wall of the ratchet wheel switching ring located between the first pushing part and the second pushing part, and when rotating to change positions, the ratchet wheel switching ring selectively enables the first pushing part to push the third ratchet tooth away from the second ratchet wheel, or enables the second pushing part to push the fourth ratchet tooth away from the second ratchet wheel, or enables the third ratchet tooth and the fourth ratchet tooth to be located in the avoidance groove, without enabling the first pushing part to push the third ratchet tooth away from the second ratchet wheel, nor enabling the second pushing part to push the fourth ratchet tooth away from the second ratchet wheel.

18. The manual tool outputting torque bidirectionally as claimed in claim 3, wherein the transmission device comprises a conversion seat fixed to the holding sleeve, the conversion seat sleeving the main shaft such that the main shaft can rotate relative to the conversion seat, the first gear and the second gear are arranged coaxial with the main shaft, and the at least two middle gears are arranged, and are uniformly distributed on a circumference of the conversion seat.

19. The manual tool outputting torque bidirectionally as claimed in claim 1, wherein the first ratchet wheel is an outer ratchet wheel, the second gear is of an annular structure, and the second ratchet wheel is an inner ratchet wheel arranged on an inner side wall of the second gear.

20. The manual tool outputting torque bidirectionally as claimed in claim 8, wherein
the first ratchet tooth, the third ratchet tooth, the fourth ratchet tooth and the second ratchet tooth are sequentially arranged in a circumferential direction of the ratchet tooth seat;
when the ratchet wheel switching ring is located at the anticlockwise position, the first switching part disengages the first ratchet tooth from the first ratchet wheel and engages the second ratchet tooth with the first ratchet wheel, and the first pushing part of the second switching parts disengages the third ratchet tooth from the second ratchet wheel and engages the fourth ratchet tooth with the second ratchet wheel, such that the main shaft rotates in the anticlockwise direction to output the torque from the handle;
when the ratchet wheel switching ring is located at the clockwise position, the first switching part disengages the second ratchet tooth from the first ratchet wheel and engages the first ratchet tooth with the first ratchet wheel, the second pushing part of the second switching parts disengages the fourth ratchet tooth from the second ratchet wheel and engages the third ratchet tooth with the second ratchet wheel, such that the main shaft rotates in the clockwise direction to output the torque from the handle; and
when the ratchet wheel switching ring is located at the fixed position, the first ratchet tooth and the second ratchet tooth both engage with the first ratchet wheel, and the third ratchet tooth and the fourth ratchet tooth both engage with the second ratchet wheel, such that the main shaft and the handle rotate in the same direction to output the torque from the handle.
